(19) United States
(12) Patent Application Publication
(10) Pub. No.: US 2025/0166345 A1
(43) Pub. Date: May 22, 2025

(54) INFORMATION PROCESSING SYSTEM, INFORMATION PROCESSING DEVICE, INFORMATION PROCESSING METHOD, AND PROGRAM

(71) Applicant: NEC Corporation, Minato-ku, Tokyo (JP)

(72) Inventors: Florian Beye, Tokyo (JP); Hayato Itsumi, Tokyo (JP); Charvi Vitthal, Tokyo (JP); Koichi Nihei, Tokyo (JP)

(73) Assignee: NEC Corporation, Minato-ku, Tokyo (JP)

(21) Appl. No.: 18/841,409

(22) PCT Filed: Mar. 2, 2022
(86) PCT No.: PCT/JP2022/008927

§ 371 Date: Aug. 26, 2024

(51) Int. Cl. G06V 10/72; G06V 10/77; G06V 10/776; G06V 10/82; H04N 19/132; H04N 19/17; H04N 19/42

(52) U.S. Cl. CPC G06V 10/72; G06V 10/7715; G06V 10/776; G06V 10/82; H04N 19/132; H04N 19/17; H04N 19/42

(57) ABSTRACT

A parameter set of a first machine learning model is determined such that a first loss function becomes larger. The first loss function indicates a degree of variation from a conditional confidence of a first image feature conditional on a third image feature to a conditional confidence of a second image feature conditional on the third image feature. The third image feature is an image feature for recognition of a subject extracted from an original image. The first image feature is discriminated in a specific region of the original image by using a first machine learning model. A parameter set of each of the second machine learning model and the third machine learning model are determined such that a second loss function becomes smaller.

### TECHNICAL FIELD

The present invention relates to an information processing system, an information processing device, an information processing method, and a program.

### BACKGROUND ART

Image compression technology is a method of converting an original image into compressed data with less information so that the original image can be restored. Image compression technology has a wide range of applications, including image transmission, and storage. Image compression technology has been applied, for example, to remote monitoring systems. Remote monitoring systems have, for example, edge devices and data centers. The edge device captures images representing the shapes of various objects in the monitored area, compresses the information in the captured images for conversion to compressed data, and transmits it to the data center. The data center restores the compressed data received from the edge device into a reconstructed image and performs image recognition to detect objects in the monitored area. The data center further presents a monitor screen showing the detected objects and a reconstructed image of the monitored area.

With the development of artificial intelligence (AI) technology, machine learning models are being applied to image compression. For example, Patent Documents 1 and 2 describe image compression techniques that apply Generative Adversarial Networks (GANs). In training machine learning models, it is conceivable to perform image recognition on the reconstructed image and impose as a constraint that the recognition rate be no lower than the recognition rate for the original image as much as possible. By using the model parameters obtained through training, the recognition rate is expected to be higher than when no constraints are given. Non-Patent Document 1 also describes an image compression technique that applies GAN. In the method described in Non-Patent Document 1, a discriminator uses a segmented image that has semantics in common with the original image data as the discrimination target to define the parameter sets of the encoder and the generator, respectively, by learning. The quantitative improvement of the reconstructed image is achieved by maintaining the features of a given image as the common meaning of the original image.

### PRIOR ART DOCUMENTS

### Patent Documents

Patent Document 1: U.S. patent Ser. No. 11/048,974
Patent Document 2: U.S. patent Ser. No. 10/944,996

### Non-Patent Document

Non-Patent Document 1: Eirikur Agustsson, Michael Tschannen, Fabian Mentzer, Radu Timofte, and Luc Van Gool, “Generative Adversarial Networks for Extreme Learned image Compression,” International Conference on Computer Vision (ICCV 2019), Oct. 27-Nov. 2, 2019.

### SUMMARY OF THE INVENTION

### Problems to be Solved by the Invention

However, the subjective quality obtained by viewing the reconstructed image is not always good. Noise patterns such as block noise, for example, may become apparent in the reconstructed image. Even if a high recognition rate is obtained by image recognition processing on the reconstructed image, the subjective quality may be rather poor.

An example object of the present invention is to provide an information processing system, an information processing device, an information processing method, and a program to solve the above-mentioned problems.

### Means for Solving the Problem

According to the first example aspect of the invention, an information processing system includes: a first discrimination means that, by using a first machine learning model on an original image, discriminates a first image feature in a specific region of the original image; a compression means that, by using a second machine learning model on the original image, generates compressed data having a reduced data amount; a restoration means that, by using a third machine learning model, generates a reconstructed image of the original image from the compressed data; a second discrimination means that, by using a fourth machine learning model on the reconstructed image, discriminates a second image feature in a specific region of the reconstructed image; a third image feature extraction means that extracts a third image feature for recognition of a subject from the original image; a fourth image feature extraction means that extracts a fourth image feature for recognition of the subject from the reconstructed image; and a model learning means that makes a parameter set of the fourth machine learning model common to a parameter set of the first machine learning model, determines the parameter set of the first machine learning model such that a first loss function becomes larger, the first loss function indicating a degree of variation from a conditional confidence of the first image feature conditional on the third image feature to a conditional confidence of the second image feature conditional on the third image feature, and determines a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to the fourth image feature.

According to the second example aspect of the invention, an information processing method is an information processing method in an information processing system, and includes: a first discrimination step of, by using a first machine learning model on an original image, discriminating a first image feature in a specific region of the original image; a compression step of, by using a second machine learning model on the original image, generating compressed data having a reduced data amount; a restoration step of, by using a third machine learning model, generating a reconstructed image of the original image from the compressed data; a second discrimination step of, by using a fourth machine learning model on the reconstructed image, discriminating a second image feature in a specific region of the reconstructed image; a third image feature extraction step of extracting a third image feature for recognition of a subject from the original image; a fourth image feature extraction step of extracting a fourth image feature for recognition of the subject from the reconstructed image; and a model learning step of making a parameter set of the fourth machine learning model common to a parameter set of the first machine learning model, determining the parameter set of the first machine learning model such that a first loss function becomes larger, the first loss function indicating a degree of variation from a conditional confidence of the first image feature conditional on the third image feature to a conditional confidence of the second image feature conditional on the third image feature, and determining a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to the fourth image feature.

According to the third example aspect of the invention, an information processing method in information processing device, and includes: a model learning means determines a parameter set of a first machine learning model such that a first loss function becomes larger, the first loss function indicating a degree of variation from a conditional confidence of a first image feature conditional on a third image feature to a conditional confidence of a second image feature conditional on the third image feature, the third image feature being an image feature for recognition of a subject extracted from an original image, the first image feature being discriminated in a specific region of the original image by using a first machine learning model on the original image, the second image feature being discriminated by using a fourth machine learning model on a reconstructed image of the original image, the reconstructed image being generated from compressed data by using a third machine learning model, the compressed data having a reduced data amount and being generated by using a second machine learning model on the original image, a parameter set of the fourth machine learning model being common to a parameter set of the first machine learning model, and determines a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to a fourth image feature for recognition of the subject from the reconstructed image.

### Effect of Invention

According to the present invention, the subjective quality of a reconstructed image and the recognition rate of image recognition for the reconstructed image can be improved.

### BRIEF DESCRIPTION OF THE DRAWINGS

FIG. 1 is a schematic block diagram showing an example configuration of the information processing system according to the first example embodiment.

FIG. 2 is a schematic block diagram showing an example of the configuration of the compression portion according to the first example embodiment.

FIG. 3 is a schematic block diagram showing an example of the configuration of the restoration portion according to the first example embodiment.

FIG. 4 is an illustration that explains the training of the discriminator.

FIG. 5 is an illustration that explains the training of the generator.

FIG. 6 is a flowchart showing an example of the image compression and restoration process in the first example embodiment.

FIG. 7 is a flowchart showing an example of the model learning process according to the first example embodiment.

FIG. 8 is a schematic block diagram showing an application example of the information processing system according to the first example embodiment.

FIG. 9 is a schematic block diagram showing a functional configuration example of the third image feature extraction portion according to the second example embodiment.

FIG. 10 is a schematic block diagram showing an example configuration of the first discrimination portion according to the second example embodiment.

FIG. 11 is a schematic block diagram showing a configuration example of the information processing system according to the third example embodiment.

FIG. 12 is a diagram showing a distribution example of image features.

FIG. 13 is a diagram showing the recognition rate for the reconstructed image.

FIG. 14 is a diagram showing a first example of a reconstructed image.

FIG. 15 is a diagram showing a second example of a reconstructed image.

FIG. 16 is a schematic block diagram showing a minimum configuration example of an information processing system.

FIG. 17 is a schematic block diagram showing a minimum configuration example of an information processing device.

### EXAMPLE EMBODIMENT

The following is a description of the example embodiments of the invention with reference to the drawings.

### First Example Embodiment

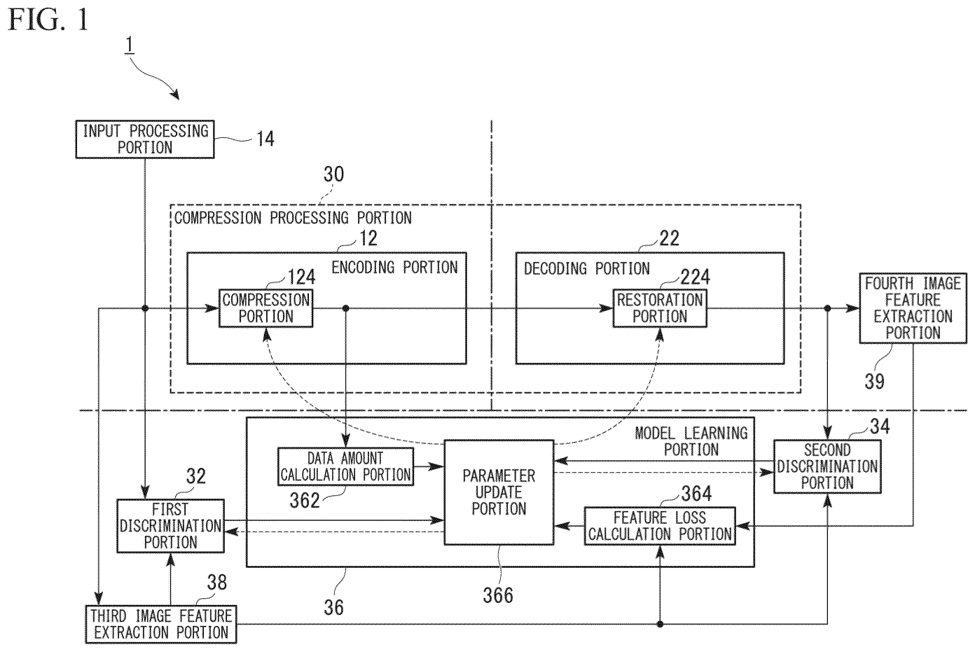

The first example embodiment shall be described below. FIG. 1 is a schematic block diagram showing a configuration example of the information processing system 1 according to the present invention. The information processing system 1 acquires image data indicating an image (original image) and compresses the data amount in the acquired image data to generate compressed data. The information processing system 1 extends the data amount in the generated compressed data to generate reconstructed data that shows the reconstructed image of the original image. The information processing system 1 extracts an image feature (referred to as a “fourth image feature” in the present application) from the reconstructed image. The information processing system 1, for example, performs image recognition processing using the extracted fourth image feature.

The information processing system 1 includes an input processing portion 14, a compression processing portion 30, a first discrimination portion 32, a second discrimination portion 34, a third image feature extraction portion 38, a fourth image feature extraction portion 39, and a model learning portion 36. The more specific components of each of these portions are as follows.

The compression processing portion 30 includes an encoding portion 12 and a decoding portion 22. The information processing system 1 may be configured as a distributed system, in which multiple devices are spatially distributed at different locations. For example, the information processing system 1 may comprise an edge device (not shown) and a data center (not shown). In the example shown in FIG. 1, one or more functional portions can be located in each individual region delimited by a single dotted line. The location or timing may vary for each individual region.

In a case where the information processing system 1 is configured as a distributed processing system including edge devices and data centers as described above, the edge devices are installed near the source of information to be processed and provide computing resources for that information. In the example shown in FIG. 1, the image data corresponds to the information to be processed. An edge device can comprise, for example, an input processing portion 14 and an encoding portion 12. In the information processing system 1, the number of edge devices is not limited to one, and may be two or more. Individual edge devices may further be connected to the imaging portion 16 (see below) by at least one of wireless and wired connections.

On the other hand, the data center executes processing related to the entire distributed processing system using various types of information provided by the edge devices. The data center may be located spatially distant from edge devices. The data center is communicatively connected to individual edge devices via a network, at least one of which is wireless and one of which is wired.

The data center comprises, for example, a decoding portion 22 and an image recognition portion 42. The data center may further have a first discrimination portion 32, a second discrimination portion 34, a third image feature extraction portion 38, a fourth image feature extraction portion 39, and a model learning portion 36.

The data center may be configured as a single piece of equipment, but is not limited thereto. The data center may be configured as a cloud that includes multiple devices and can send and receive data to and from each other. The data center consists, for example, of a server device and a model training device. The server device includes, for example, a decoding portion 22 and image recognition portion 42. The model learning device includes a first discrimination portion 32, a second discrimination portion 34, a third image feature extraction portion 38, a fourth image feature extraction portion 39, and a model learning portion 36. The model learning process performed by the model learning portion 36 may be performed in parallel with the data compression and restoration process performed by the edge device and server device in cooperation (online process) or at different times (offline process). To realize online processing, the data center may include a parameter notification portion (not shown) that, for each update step, transmits the updated amount (described below) of the parameter set of the first machine learning model, second machine learning model, third machine learning model, and fourth machine learning model determined by the model learning portion 36 to the first discrimination portion 32, second discrimination portion 34, third image feature extraction portion 38, and third image feature extraction portion 38, respectively.

Instead of or together with the data center, the edge device may further include a first discrimination portion 32, a second discrimination portion 34, a third image feature extraction portion 38, a fourth image feature extraction portion 39, and a model learning portion 36. Under that configuration, online processing may be realized. To achieve online processing, the edge device may include the parameter notification portion described above.

The input processing portion 14 acquires image data. Image data is input to the input processing portion 14, for example, from an imaging portion. The image data may be input to the input processing portion 14 from other devices. The input processing portion 14 comprises, for example, an input interface. The input processing portion 14 may comprise an imaging portion. The input processing portion 14 outputs the acquired image data to the encoding portion 12, the first discrimination portion 32, and the third image feature extraction portion 38. In the present application, the image shown in the image data acquired by the input processing portion 14 is called the “original image”, while the image data showing the original image is sometimes called the “current image data”.

The encoding portion 12 includes a compression portion 124. The compression portion 124 extracts image features that represent the features of the image shown in the image data input from the input processing portion 14. The data amount in the extracted image features is less than the image data. The image features to be extracted may differ from the first through fourth image features described below. The encoding portion 12 uses a second machine learning model when extracting image features from the image data. The compression portion 124 quantizes the determined image features and generates a data series consisting of one or more quantized values obtained by quantization as compressed data. The compression portion 124 outputs the generated compressed data to the decoding portion 22 and the model learning portion 36.

The decoding portion 22 includes a restoration portion 224.

The restoration portion 224 de-quantizes the data series forming the compressed data input from the encoding portion 12 and restores one or more quantized values of image features represented by the inversely quantized data series. The restoration portion 224 restores the image having the feature indicated by the one or more quantized values that have been determined as a reconstructed image. The restoration portion 224 uses a third machine learning model when restoring the reconstructed image from the one or more quantized values. The restoration portion 224 generates reconstructed image data indicating the restored reconstructed image and outputs the generated reconstructed image data to the second discrimination portion 34 and the fourth image feature extraction portion 39.

By providing a compression portion 124 and a restoration portion 224, the compression processing portion 30 functions as a generator that generates reconstructed image data based on image data representing the original image input from the input processing portion 14.

Image data is input to the first discrimination portion 32 from the input processing portion 14, and a third image feature is input from the third image feature extraction portion 38. The first discrimination portion 32, using the first machine learning model, sets the input third image feature as a condition, and determines, from the image indicated in the input image data, the conditional confidence of the first image feature, which is a feature of a given image in a specific region, which is a partial region thereof. A specific region is a region that is or is likely to be a region of interest (RoI) in which the observer is interested. The specific region may be the entire image or a portion of it. The first discrimination portion 32 functions as a discriminator to discriminate the first image feature from the image data. The first discrimination portion 32 outputs the conditional confidence of the first image feature determined to the model learning portion 36.

The second discrimination portion 34 receives the reconstructed image data from the restoration portion 224 and the third image feature from the third image feature extraction portion 38. The second discrimination portion 34, using a fourth machine learning model, sets the input third image feature as a condition, and determines, from the reconstructed image indicated in the input reconstructed image data, the conditional confidence of a second image feature, which is a feature of a given image in a specific region, which is a partial region thereof. The second image feature is an image feature of the same type as the first image feature. Therefore, in the fourth machine learning model, the same types of methods as in the first machine learning model are applied and the same model parameters as in the first machine learning model are used. The second discrimination portion 34 outputs the conditional confidence of the determined second image feature to the model learning portion 36.

The second discrimination portion 34 functions as a discriminator to discriminate the second image feature from the reconstructed image data. In the second discrimination portion 34, the parameter set common to the first machine learning model is set as the parameter set of the fourth machine learning model. If the reconstructed image is exactly the same as the original image shown in the image data provided by the input processing portion 14 to the first discrimination portion 32, then the confidence determined by the second discrimination portion 34 is equal to the confidence determined by the first discrimination portion 32. The more the image features of the reconstructed image differ from those of the original image, the greater the difference in confidence tends to be.

The third image feature extraction portion 38 extracts image features for subject recognition as third image features from the image shown in the image data input from the input processing portion 14. The third image feature is an image feature mainly used in the image recognition process to recognize the type and state of the subject. The third image feature is derived separately from the first and second image features. The third image feature extraction portion 38 may, for example, calculate the third image feature using a predefined arithmetic process. The third image feature may be any known image feature that is useful for subject recognition. Known image features may be used, for example, SIFT (Scaled Invariance Feature Transform), HoG (Histograms of Oriented Gradients), and the like. The third image feature extraction portion 38 may also extract a third image feature from the original image using a fifth machine learning model as a machine learning model separate from the first or fourth machine learning models. The third image feature extraction portion 38 outputs the extracted third image feature to the first discrimination portion 32, the second discrimination portion 34 and the model learning portion 36.

The fourth image feature extraction portion 39 extracts an image feature for subject recognition as a fourth image feature from the reconstructed image shown in the reconstructed image data input from the decoding portion 22. The fourth image feature should be the same type of image feature as the third image feature. If the reconstructed image is exactly the same as the original image, then the fourth image feature is equal to the third image feature. The fourth image feature extraction portion 39 may extract fourth image feature from the reconstructed image using a sixth machine learning model. In that case, the sixth machine learning model is a mathematical model of the same type as the fifth machine learning model and uses the same parameter set as the parameter set of the fifth machine learning model.

The fourth image feature extraction portion 39 outputs the extracted fourth image feature to the model learning portion 36.

The model learning portion 36 comprises a data amount calculation portion 362, a feature loss calculation portion 364, and a parameter update portion 366.

The data amount calculation portion 362 calculates the data amount of the code generated by the entropy coding process of the compressed data input from the compression portion 124. The data amount calculation portion 362 outputs the calculated data amount to the parameter update portion 366.

The feature loss calculation portion 364 receives the third image feature input from the third image feature extraction portion 38 and the fourth image feature input from the fourth image feature extraction portion 39. The feature loss calculation portion 364 calculates a feature loss function that indicates the degree of variation from the input third image feature to the input fourth image feature. The feature loss calculation portion 364 outputs the calculated feature loss function to the parameter update portion 366.

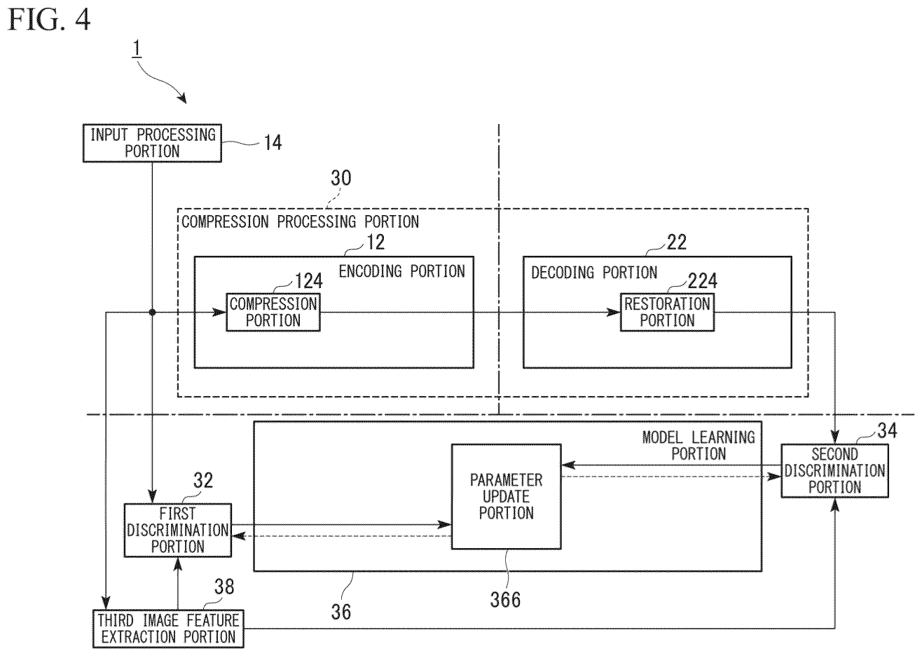

The parameter update portion 366 receives the conditional confidence of the first image feature conditional on the third image feature from the first discrimination portion 32 and the conditional confidence of the second image feature conditional on the third image feature from the second discrimination portion 34. As illustrated in FIG. 4, the parameter update portion 366 updates the parameter set of the first machine learning model so that the first loss function, which indicates the degree of variation from the conditional confidence of the first image feature conditional on the third image feature to the conditional confidence of the second image feature conditional on the third image feature, becomes larger (maximization). The parameter update portion 366 defines the parameter set of the fourth machine learning model to be equal to the parameter set of the first machine learning model.

The parameter update portion 366, for example, uses the gradient method to sequentially calculate the update amount of the parameter set of the first machine learning model at each update step, and outputs the calculated update amount to the first discrimination portion 32 and the second discrimination portion 34. Gradient methods include steepest descent, stochastic gradient descent, and others, any of which may be used. The first discrimination portion 32 updates the sum obtained by adding the update amount input from the parameter update portion 366 to the parameter set of the first machine learning model set at that time as the parameter set of the new parameter set of the first machine learning model. The second discrimination portion 34 updates the parameter set of the fourth machine learning model set at that time as a new parameter set of the fourth machine learning model, which is the sum obtained by adding the update amount input from the parameter update portion 366. By setting the initial values of the parameter set of the first machine learning model equal to the initial values of the parameter set of the fourth machine learning model, the parameter set of the first machine learning model is equal to the parameter set of the fourth machine learning model. In the present application, the process of updating the parameter sets of the first and fourth machine learning models is sometimes referred to as “discriminator training”.

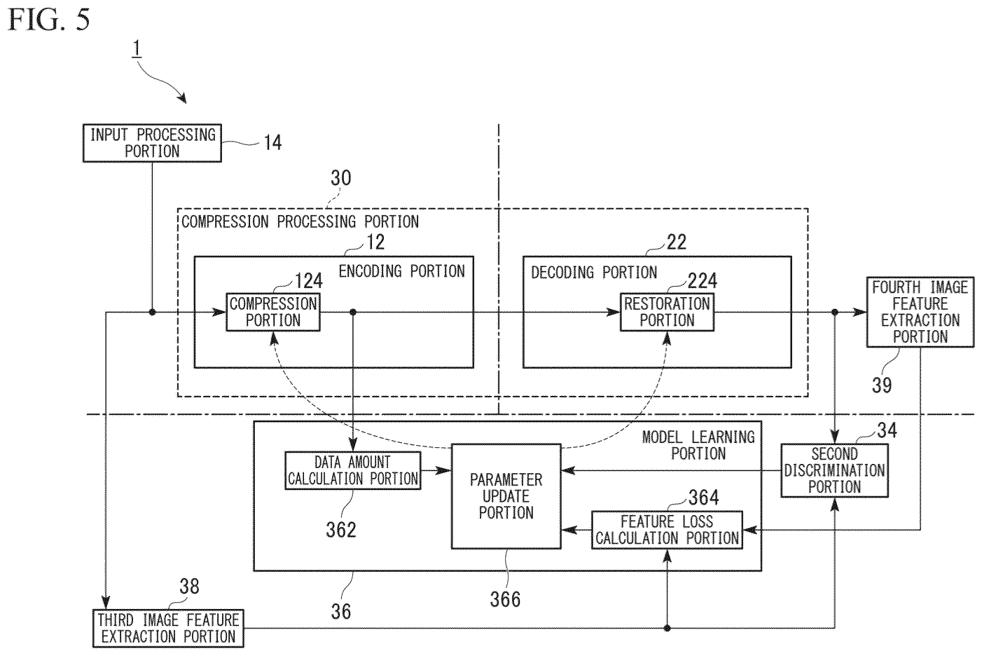

In addition to the conditional confidence from the second discrimination portion 34, the feature loss function is input to the parameter update portion 366 from the feature loss calculation portion 364. As illustrated in FIG. 5, the parameter update portion 366 updates the parameter set of the second machine learning model and the parameter set of the third machine learning model so that the second loss function obtained by combining the conditional confidence and feature loss function of the second image feature conditional on the third image feature becomes smaller (minimization). The parameter update portion 366, for example, sequentially calculates the update amount of the parameter sets of the second and third machine learning models, respectively, using the gradient method, and outputs the calculated update amount for the parameter set of the second machine learning model to the compression portion 124 and the update amount of the parameter set of the third machine learning model to the restoration portion 224. The compression portion 124 updates the sum obtained by adding the update amount from the parameter update portion 366 to the parameter set of the second machine learning model set at that point in time as a new parameter set of the second machine learning model. The restoration portion 224 updates the sum obtained by adding the update amount from the parameter update portion 366 to the parameter set of the third machine learning model set at that point in time as a new parameter set of the third machine learning model.

Note that the parameter update portion 366 may update the parameter sets of each of the second and third machine learning models so that the second loss function obtained by synthesizing the information loss function based on the data amount input from the data amount calculation portion 362 with the above second loss function becomes smaller. In the present application, the process of updating the parameter sets of the second and third machine learning models is sometimes referred to as “generator training”.

If the third image feature extraction portion 38 extracts the third image feature using the fifth machine learning model and the fourth image feature extraction portion 39 extracts the fourth image feature using the sixth machine learning model, the parameter update portion 366 may further update the parameter set of the fifth machine learning model so that the second loss function in the generator training becomes smaller. The parameter update portion 366 defines the parameter set of the sixth machine learning model to be equal to the parameter set of the fifth machine learning model. The parameter update portion 366 further sequentially calculates the update amount of the parameter set of the fifth machine learning model using, for example, the gradient method, and outputs the calculated update amount of the parameter set of the fifth machine learning model to the third image feature extraction portion 38 and the fourth image feature extraction portion 39. The third image feature extraction portion 38 updates the sum obtained by adding the update amount input from the parameter update portion 366 to the parameter set of the fifth machine learning model set at that point in time as a new parameter set of the fifth machine learning model. The fourth image feature extraction portion 39 updates the sum obtained by adding the update amount input from the parameter update portion 366 to the parameter set of the sixth machine learning model set at that point in time as a new parameter set of the sixth machine learning model. By pre-setting a value equal to the initial value of the parameter set of the fifth machine learning model as the initial value of the parameter set of the sixth machine learning model, the parameter set of the sixth machine learning model is equal to the parameter set of the fifth machine learning model.

In the present application, maximizing the first loss function includes the meaning of searching for a parameter set that makes the first loss function larger, and is not limited to absolutely maximizing the first loss function. It is possible that the first loss function is temporarily reduced in training the discriminator. Minimizing the second loss function includes the meaning of searching for a parameter set that makes the second loss function smaller, and is not limited to absolutely minimizing the second loss function. It is possible that the second loss function is temporarily reduced in the training of the generator.

The parameter update portion 366 may alternate between training the discriminator and training the generator for each parameter set update step. The parameter update portion 366 determines the parameter set of the fourth machine learning model to be equal to the parameter set of the first machine learning model at each update step. In the case of determining the parameter set of the fifth machine learning model, the parameter update portion 366 determines the parameter set of the sixth machine learning model to be equal to the parameter set of the fifth machine learning model at each update step.

The parameter update portion 366 may repeat the training of the discriminator and the generator a predetermined number of times, or it may run until it is determined that any parameter set has converged. The parameter update portion 366 can determine whether the first parameter set, and thus the fourth parameter set, has converged, for example, by whether the magnitude of the difference between the first loss function before the parameter set update and the first loss function before the update is less than or equal to a predetermined threshold for the magnitude of the difference of the first loss function. It is also possible to determine whether the second and third parameter sets (and the fifth parameter set, if applicable) have converged by whether the magnitude of the difference between the second loss function before the parameter set update and the second loss function before the update is less than or equal to a predetermined threshold for the magnitude of the difference of the second loss function.

In training the discriminator, the parameter update portion 366 may set the target value of the conditional confidence to 1 for the original image in which the first image feature appears on condition that the third image feature appears in the specific region, set the target value of the confidence to 0 for the original image in which neither the first nor third image feature appears in the specific region, and set the target value of the confidence to 0 for other image features that do not appear in the original image. The parameter update portion 366 may train the discriminator so that the estimated value of the conditional confidence for the second image feature estimated for the reconstructed image corresponding to the original image in which the first image feature appears on condition that the third image feature appears, and the estimated value of the conditional confidence for the second image feature estimated for the reconstructed image corresponding to the original image in which neither the third image feature nor the first image feature appears, approach their respective target values. This means that the respective value ranges of the conditional confidence calculated by the first discrimination portion 32 and the conditional confidence calculated by the second discrimination portion 34 are bounded by a real number between 0 and 1. Conversely, the parameter update portion 366 may train the generator without the aforementioned estimates being constrained to their respective target values.

The first discrimination portion 32 receives the update amount of the parameter set of the first machine learning model from the parameter update portion 366. The second discrimination portion 34 receives the update amount of the parameter set of the fourth machine learning model (equal to the update amount of the parameter set of the first machine learning model) from the parameter update portion 366. The first discrimination portion 32 performs the update by adding the input update amount of the parameter set of the first machine learning model to the parameter set of the first machine learning model at that time. The second discrimination portion 34 performs the update by adding the input update amount of the parameter set of the fourth machine learning model to the parameter set of the fourth machine learning model at that time.

The compression portion 124 receives the update amount of the parameter set of the second machine learning model from the parameter update portion 366. The restoration portion 224 receives the update amount of the parameter set of the third machine learning model from the parameter update portion 366. The compression portion 124 and the restoration portion 224 perform the update by adding the input update amount of the parameter set of the fourth machine learning model to the parameter set of the third machine learning model at that time.

As described above, the training of the discriminator maximizes the first loss function. The first loss function indicates the degree of variation in the conditional confidence of the second image feature input from the second discrimination portion 34 from the conditional confidence of the first image feature input from the first discrimination portion 32. The conditional confidence of the first image feature and the conditional confidence of the second image feature are each conditional on the third image feature.

The first loss function is an indicator that quantitatively indicates the change in confidence of the image features discriminated by the first discrimination portion 32 and discrimination portion 34, due to compression and restoration. The first loss function is also called Generative Adversarial Network (GAN) loss. The first loss function L_{D} quantifies, for example, the degree of variation (deviation) between the distribution of the conditional confidence D(x|f) of the first image feature conditional on the third image feature f and the distribution of the conditional confidence D(G(E(x))|f) of the second image feature conditional on the third image feature f, as shown in Equation (1).

$$[ Equation 1 ]$$

$$\begin{matrix}{L}_{D} = {E}_{x ∼ p ( x )} [ - log D ( x \vert f ) - log ( 1 - D ( G ( E ( x ) ) \vert f ) ) ] , ] \\ f = F ( x )\end{matrix} \qquad ( 1 )$$

In Equation (1), E_{x˜p(x)} [ . . . ] denotes the expected value of . . . where x denotes the original image. p(x) denotes the probability distribution of the original image x. That is, x˜p(x) denotes the set of data from which the original image x is obtained with probability distribution p(x), the supervised data used for learning. Generally, supervised data consists of a large amount of image data.

E(x) indicates the probability of the code E(x) obtained by encoding the image x. G(E(x)) indicates the reconstructed image x′ obtained by decoding the code E(x). In Equation (1), the expected value of the sum of the logarithm of the distribution of the conditional confidence D(x|f) of the first image feature and the logarithm log(1−D(G(E(x)))) of the conditional inverse confidence of the second image feature conditional on the third image feature f. The conditional inverse confidence of the second image feature is equal to the difference 1−D(G(E(x))|f) of the conditional confidence D(G(E(x))|f) of the second image feature conditional on the third image feature f from 1. In Equation (1), the conditional confidence D(x|f) of the first image feature is complementary to the conditional confidence D(G((x))|f) of the second image feature. That is, an increase in the conditional confidence D(x|f) of the first image feature decreases the first loss function L_{D}, whereas an increase in the conditional confidence D(G(E(x))|f) of the second image feature decreases the first loss function L_{D}. In the following description, the function that determines the third image feature f from the original image x is described as F(x).

The first image feature and second image feature are not limited to one type each, but may each contain multiple types of image features as elements and may be constituted by combining these elements.

In addition, the second loss function is minimized in the training of the generator. The second loss function is a measure of the degree of variation of the reconstructed image x′ from the original image x. The second loss function contains the generator loss and the feature loss (feature loss function) as components. Generator loss indicates the degree of variation in the reconstructed image due to encoding and decoding. In the present example embodiment, the logarithm of the conditional confidence D(x′|f) of the second image feature conditional on the third image feature f is used as the generator loss. The feature loss indicates the degree of variation of the fourth image feature F (x′) from the third image feature f due to encoding and decoding. In the present example embodiment, the L1 norm for the difference between the fourth image feature and the third image feature, | |F(x′)−F(x)|₁, is used as the feature loss. The L1 norm is also called the first order norm. The L1 norm is a scalar quantity that corresponds to the sum of the absolute values of the element values of a vector and gives smaller values the sparser the vector elements are. The use of the L1 norm induces updates to individual element values without excessive arithmetic operations.

The second loss function may further include bitrate loss as a component. In the present application, bit-rate loss is sometimes referred to as the “information loss function.” The bit rate loss indicates the amount of data in the compressed data relative to the original image x. Compressed data consists of the code obtained by compression coding the original image x. The amount of data input from the data amount calculation portion 362 is used as the bit rate loss.

In the example in Equation (2), the second loss function L_{E, G, Q} is given as the expected value of the weighted sum of the generator loss, feature loss, and bit-rate loss under the probability p(x) of occurrence of the current image x. Generator loss, feature loss, and bit rate loss are shown in the first, second, and third terms on the right-hand side of Equation (2), respectively. α and β are weight coefficients for generator loss and feature loss, respectively. The weight coefficients α and β are positive real values, respectively. The weight coefficient for bit rate loss is normalized as 1.

$$[ Equation 2 ]$$

$$\begin{matrix}{L}_{E , G , Q} = {E}_{x ∼ p ( x )} [ - α log D ( {x}^{′} \vert f ) + β {‖ F ( {x}^{′} ) - f ‖}_{1} - log Q ( z ) ] , \\ f = F ( x ) , \\ z = E ( x ) , \\ {x}^{′} = G ( z )\end{matrix} \qquad ( 2 )$$

The first machine learning model through the sixth machine learning model may be any type of neural network, such as CNN (Convolutional Neural Network), RNN (Recurrent Neural Network), or the like. The first machine learning model through sixth machine learning model may be mathematical models of types other than neural networks, such as random forest or the like. However, the same type of mathematical model as the first machine learning model is used as the fourth machine learning model. The same type of mathematical model as the fifth machine learning model is used as the sixth machine learning model.

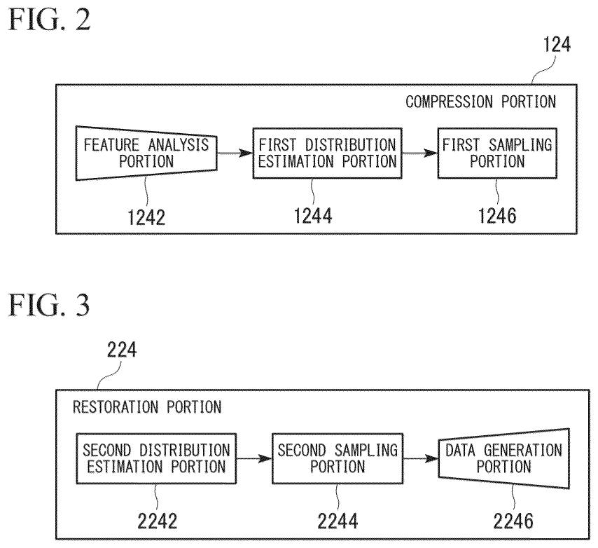

Next, an example configuration of the compression portion 124 shall be described. FIG. 2 is a schematic block diagram showing an example configuration of the compression portion 124. The compression portion 124 comprises a feature analysis portion 1242, a first distribution estimation portion 1244, and a first sampling portion 1246.

The feature analysis portion 1242 analyzes the image features representing the features of the image represented by the input image data using a first type machine learning model as the first feature value, and outputs the determined first feature value to the first distribution estimation portion 1244. Image data typically shows the signal value for each pixel. The first type of machine learning model is a mathematical model that forms part of the second machine learning model. The image features to be analyzed may be specific image features, for example, luminance gradients, edge distributions, and the like. If the first type of machine learning model is a neural network, it may be the output value for each node in a given layer. A given layer is not limited to the output layer, but may be an intermediate layer.

With one or more element values included in the first feature value input from the feature analysis portion 1242 serving as an input value, the first distribution estimation portion 1244 estimates the first probability distribution of quantized values for each input value using the second type machine learning model. The first distribution estimation portion 1244 outputs the estimated first probability distribution to the first sampling portion 1246. The quantized values can be distributed over a given value range and can be discretized numbers. The second type machine learning model is a mathematical model that forms part of the second machine learning model and is separate from the first type machine learning model. The first probability distribution consists of probabilities for each quantized value in a given value range.

The second type machine learning model is, for example, a mixture model that defines as the first probability distribution a probability distribution containing, for each quantized value, normalized probabilities of the product of the prior probability of that quantized value and the conditional probability of the input value conditioned on that quantized value. Normalization is achieved by dividing by the sum of the products of each quantized value in the value range.

The first distribution estimation portion 1244 uses, for example, a Gaussian Mixture Model (GMM) to calculate the conditional probability of the input value for each quantized value and the prior probability for each quantized value. The Gaussian Mixture Model is a mathematical model in which a given number of normal distributions (Gaussian functions) are used as basic functions, and the continuous probability distribution is represented as a linear combination of these basic functions. Thus, the parameter set of the Type 2 machine learning model includes the individual normal distribution parameters: weight coefficient, mean, and variance. All of these parameters are expressed as real numbers. Thus, the conditional and prior probabilities, as well as the probability of each quantized value determined using them, are differentiable with respect to the above parameters.

The first sampling portion 1246 samples one quantized value from a set value range according to the first probability distribution input from the first distribution estimation portion 1244, and defines the sampled quantized value as the first sample value. The first sampling portion 1246 generates, for example, a pseudo-random number that is any one of the quantized values in that value range, so that it appears with the probability of that quantized value. The first sampling portion 1246 defines the generated pseudo-random number as the first sample value. The first sampling portion 1246 accumulates the defined first sample values in the order in which they were obtained and generates a data series containing a predetermined number of first sample values as compressed data. The first sampling portion 1246 outputs the generated compressed data to the decoding portion 22.

Next, an example configuration of the restoration portion 224 shall be described. FIG. 3 is a schematic block diagram showing an example configuration of the restoration portion 224. The restoration portion 224 is constituted by a second distribution estimation portion 2242, a second sampling portion 2244, and a data generation portion 2246.

The second distribution estimation portion 2242 estimates the probability distribution corresponding to each of the first sample values included in the data series forming the compressed data input from the encoding portion 12 as a second probability distribution using a third type machine learning model. The second distribution estimation portion 2242 outputs second probability distribution information indicating the estimated second probability distribution to the second sampling portion 2244. The third type machine learning model can be any mathematical model that can determine the probability distribution using a continuous probability density function corresponding to the first sample value. For example, GMM is available as a type three machine learning model. In that case, the second probability distribution information includes the parameters of the individual normal distributions: weight coefficient, mean, and variance.

The second sampling portion 2244 samples one real value from a set value range according to the second probability distribution given by the second probability distribution information input from the second distribution estimation portion 2242. Here, the second sampling portion 2244, for example, generates a pseudo-random number that is a real number that is one of the real numbers in that value range, so that it appears with the probability for that real number value, and determines the real number from which the generated pseudo-random number is sampled. The second sampling portion 2244 then determines the quantized value obtained by quantizing the sampled real value as the second sample value. The second sampling portion 2244 outputs the determined second sample value to the data generation portion 2246.

The data generation portion 2246, using the second sample value input from the second sampling portion 2244 as an element value, determines a second feature value that includes one or more element values. For an image feature defined as a second feature value, the data generation portion 2246 generates reconstructed image data for the reconstructed image with the feature indicated by that image feature using a type four machine learning model. The data generation portion 2246 outputs the generated reconstructed image data to the fourth image feature extraction portion 39 and the second discrimination portion 34. The fourth type machine learning model is a machine learning model that forms part of the third type machine learning model and is distinct from the third type machine learning model. The fourth type machine learning model can be, for example, the same type of mathematical model as the first type machine learning model. If the first type machine learning model is a neural network, the fourth type machine learning model should also be a neural network. According to the configurations shown in FIG. 2 and FIG. 3, the image features of the original image are non-deterministically quantized.

The configuration example of the compression portion 124 and the configuration of the restoration portion 224 are not limited to those illustrated in FIG. 2 and FIG. 3, respectively. In the compression portion 124, the first distribution estimation portion 1244 and the first sampling portion 1246 may be omitted. In that case, the compression portion 124 may use a predetermined quantization interval to determine the quantized value for the first feature value obtained from the feature analysis portion 1242. The compression portion 124 outputs to the decoding portion 22 as compressed data a data series consisting of determined quantized values accumulated as first sample values. In the restoration portion 224, the second distribution estimation portion 2242 and the second sampling portion 2244 may be omitted. In that case, the restoration portion 224 outputs the first sample value contained in the data series forming the compressed data input from the encoding portion 12 to the data generation portion 2246 as the second sample value.

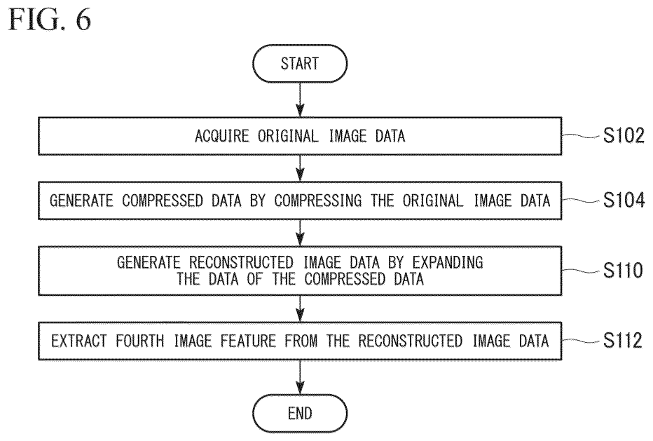

Next, an example of the image compression and restoration process according to the present example embodiment shall be described. FIG. 6 is a flowchart showing an example of the image compression and restoration process.

(Step S102) The input processing portion 14 acquires image data to be processed and outputs it to compression portion 124.

(Step S104) The compression portion 124 compresses the data in the image data using the second machine learning model to generate compressed data consisting of a data series that includes a code indicating the feature of the original image. The compression portion 124 outputs the generated compressed data to the decoding portion 22.

(Step S110) The restoration portion 224 uses the third machine learning model to decompress the data in the data series forming the compressed data input from the encoding portion 12 and restores it to the reconstructed image data representing the reconstructed image. The restoration portion 224 outputs the reconstructed image data to the fourth image feature extraction portion 39.

(Step S112) The fourth image feature extraction portion 39 extracts the fourth image feature from the reconstructed image data input from the restoration portion 224. The process in FIG. 6 is then completed. The extracted fourth image feature is used, for example, in image recognition processing.

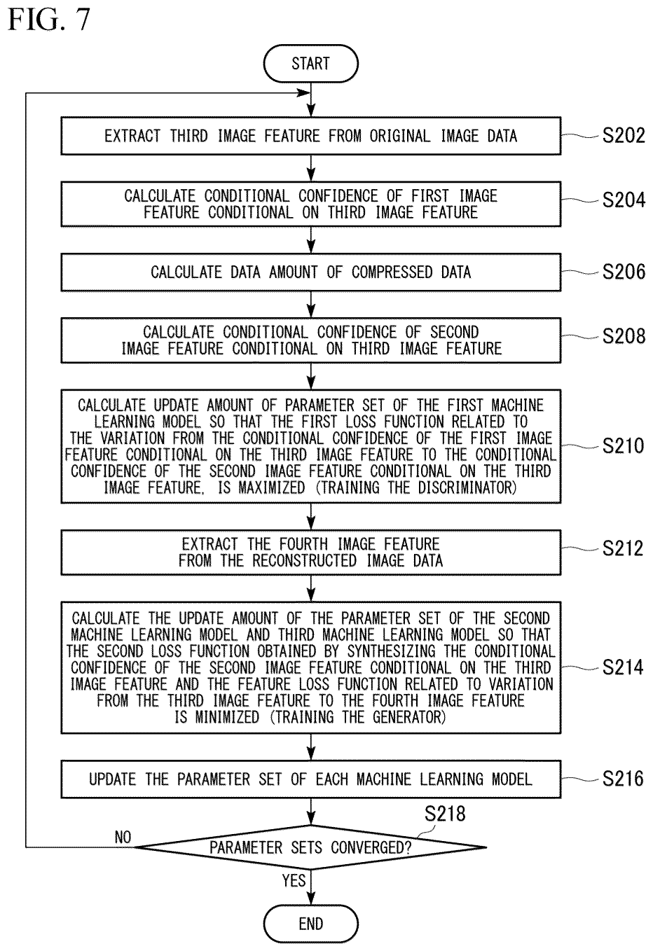

Next, an example of this model learning process is described. FIG. 7 is a flowchart showing an example of the model learning process according to the present example embodiment.

(Step S202) The third image feature extraction portion 38 extracts the third image feature from the original image shown in the image data obtained from the input processing portion 14. The third image feature extraction portion 38 outputs the extracted third image feature to the first discrimination portion 32.

(Step S204) The first discrimination portion 32 uses the first machine learning model to calculate the conditional confidence of the first image feature conditional on the third image feature input from the third image feature extraction portion 38. The first image feature is discriminated from the original image shown in the image data obtained from the input processing portion 14.

(Step S206) The data amount calculation portion 362 determines the data amount of the compressed data obtained from the compression portion 124.

(Step S208) The second discrimination portion 34 uses the fourth machine learning model to calculate the conditional confidence of the second image feature conditional on the third image feature input from the third image feature extraction portion 38. The second image feature is discriminated from the reconstructed image shown in the reconstructed image data obtained from the restoration portion 224.

(Step S210) The parameter update portion 366 calculates the update amount of the parameter set of the first machine learning model so that the first loss function, which indicates the degree of variation from the conditional confidence of the first image feature conditional on the third image feature to the conditional confidence of the second image feature conditional on the third image feature, is maximized (training the discriminator).

(Step S212) The fourth image feature extraction portion 39 extracts the fourth image feature from the reconstructed image shown in the reconstructed image data input from the restoration portion 224. The fourth image feature extraction portion 39 outputs the extracted fourth image feature to the parameter update portion 366.

(Step S214) The parameter update portion 366 calculates the update amount of the parameter set of the second machine learning model and the update mount of the parameter of the third machine learning model so that the second loss function, which is obtained by synthesizing the conditional confidence of the second image feature conditional on the third image feature and the feature loss function indicating the degree of variation from the third image feature to the fourth image feature, is minimized (training the generator).

(Step S216) The parameter update portion 366 updates the parameter set of each of the first through fourth machine learning models using the update amounts determined respectively.

(Step S218) The parameter update portion 366 determines whether the parameter sets have converged. If a determination of convergence is made (Step S218 YES), the process in FIG. 7 is terminated. If it is determined that convergence has not occurred (Step S218 NO), the process returns to Step S202.

The model learning process shown in FIG. 7 may be executed in parallel with the process shown in FIG. 6 (online learning) or independently of the process shown in FIG. 6 (offline learning). The model learning portion 36 may include functional portions corresponding to the input processing portion 14, compression portion 124, restoration portion 224, first discrimination portion 32, second discrimination portion 34, and fourth image feature extraction portion so that the model learning process can be performed independently. The information processing system 1 may be realized as an information processing device including the model learning portion 36.

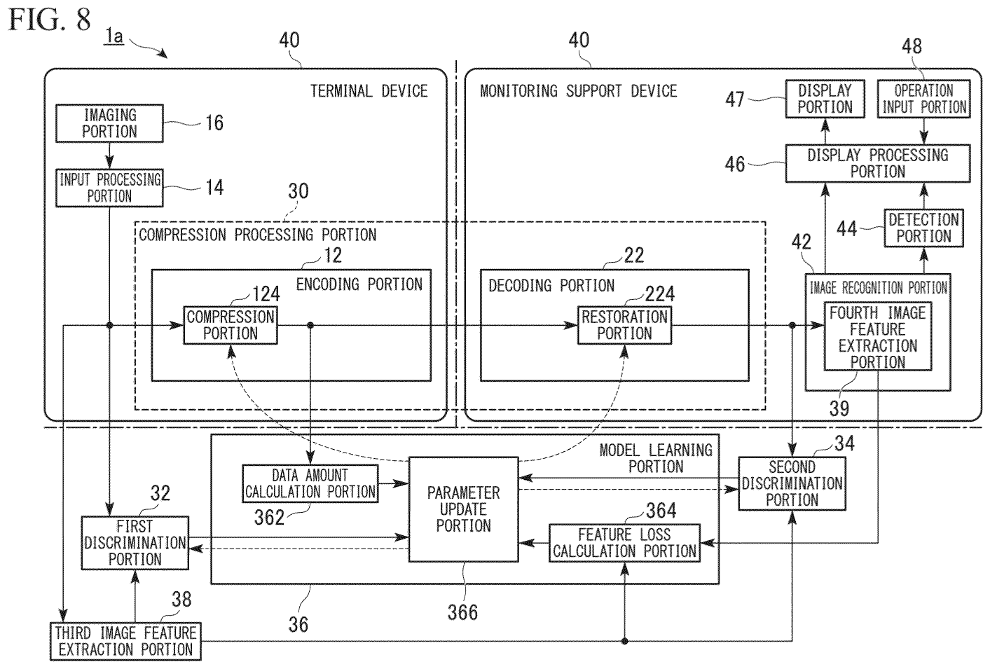

Next, an application example of the information processing system 1 will be described. FIG. 8 is a schematic block diagram showing an application example of the information processing system 1a according to the present example embodiment. The information processing system 1a is an example of application to a remote monitoring system. The object to be monitored is, for example, traffic conditions on a road. The information processing system 1a further includes the imaging portion 16 and a monitoring support device 40 with respect to the information processing system 1. The monitoring support device 40 includes the decoding portion 22, the image recognition portion 42, a detection portion 44, a display processing portion 46, a display portion 47, and an operation input portion 48.

The imaging portion 16 captures images within a predetermined field of view and outputs image data showing the captured images to the input processing portion 14. The area to be monitored is included in the field of view. The imaging portion 16 is, for example, a digital video camera. In the example in FIG. 8, the input processing portion 14 is separate from the imaging portion 16.

The image recognition portion 42 includes the fourth image feature extraction portion 39. The image recognition portion 42 uses the fourth image feature extracted by the fourth image feature extraction portion 39 to perform image recognition processing using known methods to generate recognition information indicating recognition results. Recognition results include, for example, the type of subject, such as a vehicle or pedestrian; the state of the subject, such as its speed of movement or direction; and other objects and their display positions. In the image recognition process, a machine learning model separate from the first machine learning model to the sixth machine learning model may be used, or a machine learning model consisting in part of the sixth machine learning model used to extract the fourth image feature may be used. The image recognition portion 42 outputs the generated recognition information to the detection portion 44. The image recognition portion 42 outputs the reconstructed image data input from the decoding portion 22 to the display processing portion 46.

The detection portion 44 detects recognition information indicating a predetermined event (e.g., an approach between a vehicle and another object (e.g., a vehicle or a pedestrian), or traffic congestion on a road, etc.) to be notified to a user (e.g., a monitor) using predetermined detection rules set in advance from recognition information input from the image recognition portion 42 (event detection). The detection portion 44 may reject recognition information indicating other events. The detection portion 44 outputs the detected recognition information to the display processing portion 46.

The display portion 47 displays a display screen based on display screen data input from the display processing portion 46. The display portion 47 is, for example, a display.

The operation input portion 48 accepts user operations and outputs operation information corresponding to the accepted operations to the display processing portion 46. The operation input portion 48 may comprise dedicated components such as buttons, as well as knobs, for example, or general-purpose components such as a touch sensor, mouse, as well as a keyboard, for example.

The display processing portion 46, together with the display portion 47 and the operation input portion 48, constitute a user interface. The display processing portion 46 mainly composes a display screen in which part or all of the reconstructed image shown in the reconstructed image data input from the image recognition portion 42 is arranged in a predetermined display area, and performs processing for causing that display screen to be displayed on the display portion 47.

The display processing portion 46 controls the display functions of the display screen according to the operation information input from the operation input portion 48. The display screen data indicating the display screen containing the reconstructed image is output to the display portion 47. The display portion 47 displays the display screen shown in the display screen data input from display processing portion 46. The display processing portion 46 updates the specific region based on, for example, region indication information about the display region of the reconstructed image that is input from the operation input portion 48. The updated specific region can be set according to the operation of the user viewing the reconstructed image included in the display screen. The update processing portion 462 obtains, as a new specific region, the region that is part of the original image or reconstructed image as region indication information and indicated by the operation information from the operation input portion.

The update processing portion 462 may, for example, have dedicated functions for explicitly identifying specific regions from the reconstructed image in response to operation information, or may have functions for implicitly identifying specific regions. When identifying the specific region implicitly, the update processing portion 462, after an operation is performed that infers user interest in a specific area in the function of the display size or display position adjustment function for the reconstructed image, may estimate the region corresponding to the display frame of the display screen as the specific region when no change of display size or display position is indicated for a predetermined waiting time (e.g., 1-3 seconds) or longer. Operations in which user interest is inferred are, for example, changing the display position, enlargement, or a combination thereof. The update processing portion 462 outputs specific region information indicating new specific region information to the parameter update portion 366. The specific region information that is output may be used to train a discriminator.

The update processing portion 462 may further output recognition information obtained from image recognition portion 42 to the display portion 47 to obtain subject information regarding subject features in the specific region. Here, the features of the subject can be set according to the operation of the user viewing the reconstructed image. The update processing portion 462 obtains subject information indicating the features of the subject in the specific region from the operation information input from the operation input portion. The update processing portion 462 outputs the acquired subject information to the parameter update portion 366. The specific region information that is output may be used to learn the fourth image feature, and thus the third image feature, used to detect that subject in the training of the generator. In that case, for the original image, the parameter update portion 366 may set the target value of the conditional confidence level for the known first image feature included in the original image as 1 and a target value of the conditional confidence level for other image features not included in the original image as 0 in the updated specific region as correct information. The parameter update portion 366 may update the parameter sets of individual machine learning models so that the confidence estimate for the second image feature and the confidence estimates for other image features estimated for the reconstructed image approach their respective target values.

As explained above, according to the information processing system 1 of the present example embodiment, the first machine learning model is used on the original image to discriminate the first image feature in the specific region of the original image, the second machine learning model is used on the original image to generate compressed data with a reduced data amount, the third machine learning model is used to generate a reconstructed image of the original image from the compressed data, and the fourth machine learning model is used on the reconstructed image to discriminate the second image feature in the specific region of the reconstructed image. The information processing system 1 extracts the third image feature for recognition of the subject from the original image, extracts the fourth image feature for recognition of the subject from the reconstructed image, makes a parameter set of the fourth machine learning model common to the parameter set of the first machine learning model, determines a parameter set of the first machine learning model such that the first loss function indicating the degree of variation from the confidence of the first image feature conditional on the third image feature to the confidence of the second image feature conditional on the third image feature becomes larger, and determines a parameter set for each of the second and third machine learning models such that the second loss function, obtained by synthesizing the confidence of the second image feature conditional on the third image feature and a feature loss function indicating the degree of variation from the third image feature to the fourth image feature, becomes smaller.

According to this configuration, a third image feature for recognition extracted from the original image and used for image recognition is set as a condition, and the parameter sets of the first machine learning model or the fourth machine learning model are determined so that the variation from the first image feature for discrimination is significant and so that a reconstructed image is obtained from which the second image feature for discrimination can be extracted. Therefore, the reconstructed image obtained using the second and third machine learning models has improved visual quality by being conditioned on the third image feature and having the second image feature with significant variation from the first image feature. The same method used to extract the third image feature from the original image can be used to extract the fourth image feature from the reconstructed image so that the variation from the third image feature is reduced. Therefore, it is possible to reconcile the subjective quality seen in the reconstructed image with the recognition rate of image recognition using the fourth image feature extracted from the reconstructed image.

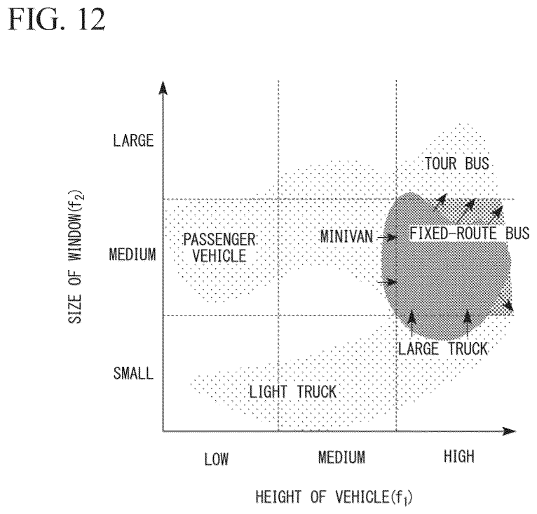

The fourth image feature extracted from the reconstructed image obtained without conditioning on the third image feature used for image recognition tends to differ significantly from the ideal third image feature. FIG. 12 illustrates the distribution of the fourth image feature for each vehicle type to be recognized as shaded, and the distribution of the third image feature for route buses to be recognized as filled. The horizontal and vertical axes indicate the height and window size of the recognized vehicle as element values of the third or fourth image feature, respectively. In this example, the range of the fourth image feature that should be recognized as “fixed-route bus” has degraded into the range of being recognized as “minivan” or “large truck”, and the range of the fourth image feature that should be recognized as “tour bus” has degraded into the range of being recognized as “fixed-route bus”. In contrast, in the present example embodiment, the variation from the third image feature to the fourth image feature is suppressed by using the reconstructed image obtained using the parameter set conditioned by the third image feature. Therefore, the accuracy of image recognition can be ensured.

The second loss function may be further synthesized with an information loss function based on the information content of the compressed data.

According to this configuration, the data amount of compressed data for transmission of the original image can be reduced while both improving the visual quality of the reconstructed image and the recognition rate of image recognition.

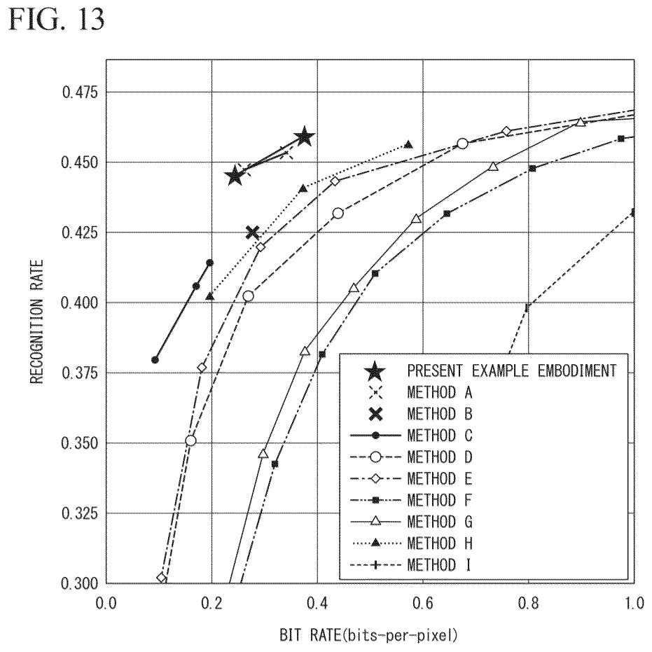

FIG. 13 illustrates the relationship between recognition rate and bit rate obtained from image recognition processing for reconstructed images obtained using the present example embodiment and other methods. In general, the higher the bit rate, the higher the recognition rate, but the recognition rate is higher than when using reconstructed images obtained by other methods. In the case where the reconstructed image obtained by Method A was used, the recognition rate was almost the same as that of the present example embodiment. In Method A, the reconstructed image was generated using model parameters obtained without training the discriminator as in the present example embodiment. This results in a tendency for the subjective quality of the reconstructed image to be inferior. Recognition rates based on reconstructed images generated by other methods are significantly lower than the recognition rate achieved by the present example embodiment. In Method B, the reconstructed image was generated using a parameter set determined without conditioning on the third image feature in the present example embodiment. This approach also degrades subjective quality. Methods C and D both refer to the method proposed by Balle et al. (2018). Method E indicates the video coding and decoding method specified in ITU-T H.264. Method F indicates the video coding and decoding method specified in ITU-T H.265. Method G represents the method proposed by Mentzer et al. (2020). Method I indicates the JPEG (Joint Photographic Experts Group) system.

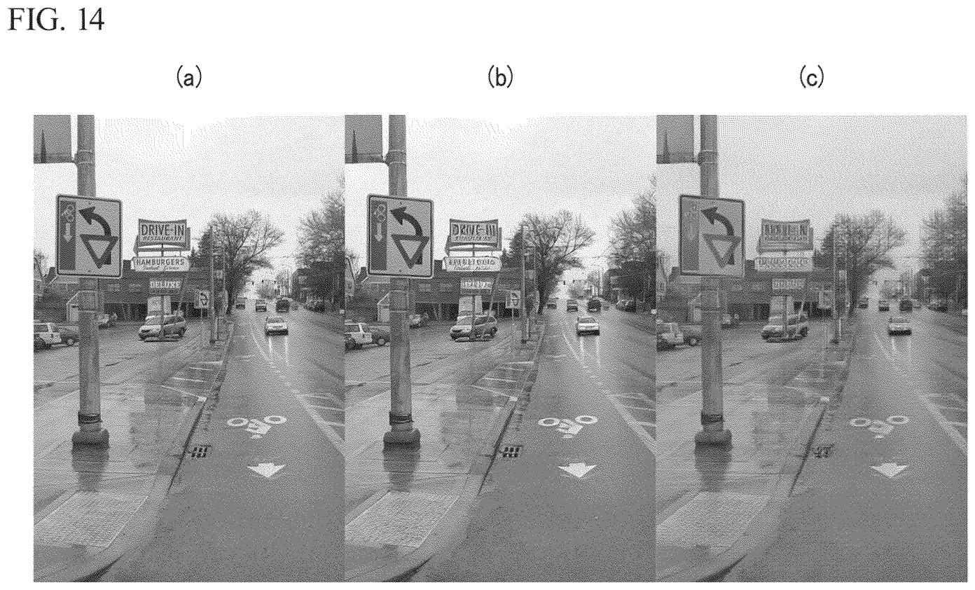

FIG. 14 shows (a) the original image, (b) the reconstructed image of the present example embodiment, and (c) a comparative example. The comparative example is a reconstructed image using the parameter set from learning without conditions in the third image feature. In the example shown in the figure, the reconstructed image for the present example embodiment has a higher subjective quality than the reconstructed image for the comparison example. In the reconstructed image of the present example embodiment, block noise does not appear as in the comparative example, and the image is clearly reproduced even in the distant background.

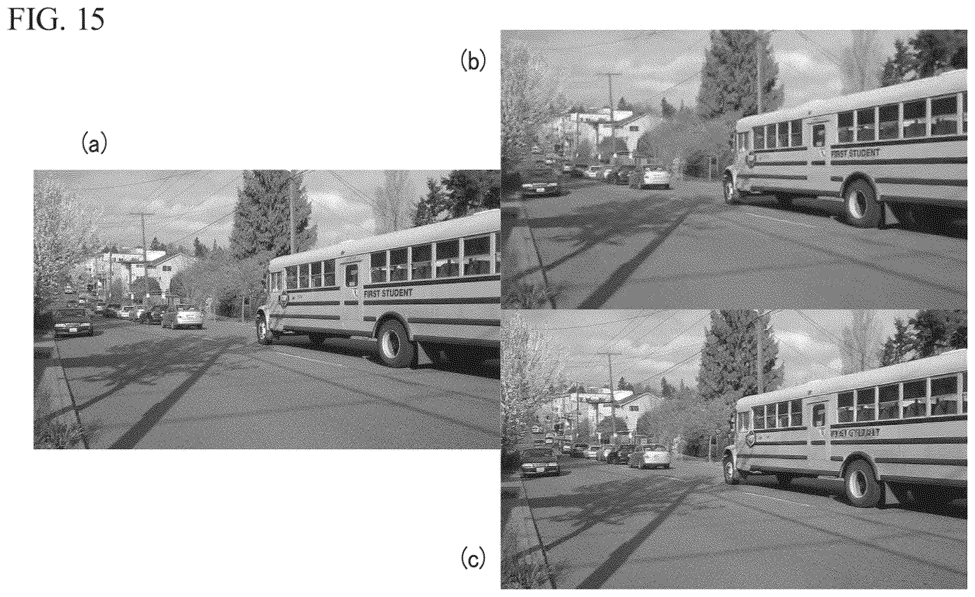

FIG. 15 shows (a) the original image, (b) the reconstructed image of the present example embodiment, and (c) a comparative example. The comparative example shows a reconstructed image using High Efficiency Video Coding (HEVC). Compression and restoration were performed to equalize the bit rate between (b) and (c). Again, the reconstructed image of the present example embodiment has a higher subjective quality than the reconstructed image for the comparison example. In the reconstructed image of the present example embodiment, blurred hazes, stripes, and other noises do not appear as in the comparative example, and so the image is reproduced clearly.

Next, other example embodiments will be described. In the following description, the main differences from the first example embodiment will be discussed. Unless otherwise specified, common reference numerals will be used to refer to configurations and processes in common with the first example embodiment. A common reference numeral can also include cases where the parent number, which is a part of that reference numeral, (e.g., “1” for “information processing system 1a”), is common and the child number (e.g., “a”) is different.

### Second Example Embodiment

Next, the second example embodiment shall be described. The third image feature for the second example embodiment includes as elements image features for recognition of multiple types of subjects. By extension, the fourth image feature also includes image features for recognition of subjects of the same type as those multiple types. The image recognition process using the fourth image feature can improve the recognition accuracy of the type of subject corresponding to the image feature included as an element.

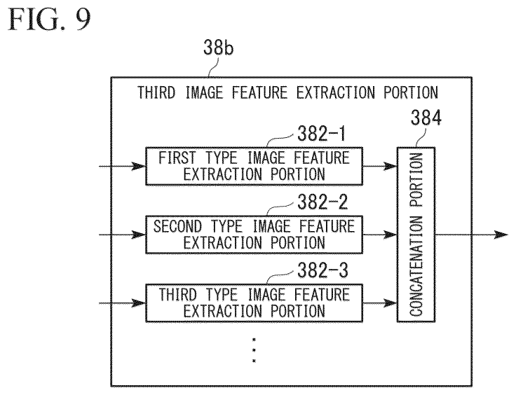

The information processing system 1b (not shown) of the present example embodiment includes a third image feature extraction portion 38b in place of the third image feature extraction portion 38. FIG. 9 is a schematic block diagram showing an example of the functional configuration of the third image feature extraction portion 38b of the present example embodiment.

In the example of FIG. 9, the third image feature extraction portion 38b extracts three types of image features for recognition, concatenates the three extracted image features, and outputs them as third image features. The third image feature extraction portion 38b includes a first type image feature extraction portion 382-1 to third type image feature extraction portion 382-3 and a concatenation portion 384. The first type image feature extraction portion 382-1 to the third type image feature extraction portion 382-3 each include a mathematical model for calculating the first type image feature or the third type image feature from the original image, and respectively output the calculated first type image feature to the third type image feature to the concatenation portion 384.

The concatenation portion 384 concatenates the calculated first type image feature to third type image feature input from the first type image feature extraction portion 382-1 to third type image feature extraction portion 382-3, respectively, in parallel to constitute the third type image feature. The concatenation portion 384 outputs the configured third image feature to the first discrimination portion 32 and second discrimination portion 34.

The fourth image feature extraction portion 39 has the same configuration as the third image feature extraction portion 38. That is, the fourth image feature extraction portion 39 extracts multiple types of image features from the reconstructed image and concatenates the extracted multiple types of image features to constitute the fourth image feature. The functions and configuration of the fourth image feature extraction portion 39 are referenced from the description of the third image feature extraction portion 38. The number of image features included as elements in type three and type four image features is not limited to three, but may be two, or four or more.

Individual image features that are elements of the third and fourth image features may be used for conditioning in the first discrimination portion 32 and the second discrimination portion 34, respectively, and the confidence or intermediate values obtained may be concatenated between the types of image features. Each individual image feature is represented by a vector with multiple element values, and the number of dimensions (number of elements) can differ between types of image features. The first discrimination portion 32 and the second discrimination portion 34 may resample the individual image features that are the elements so that the number of dimensions is equal to the number of dimensions of the first and second image features for each type of image feature, respectively. In resampling, downsampling is performed to decrease the dimensionality of the image features to equal the dimensionality of the first or second image feature, and oversampling is performed to increase the dimensionality of the image features. Known interpolation processes may be applied in downsampling or oversampling.

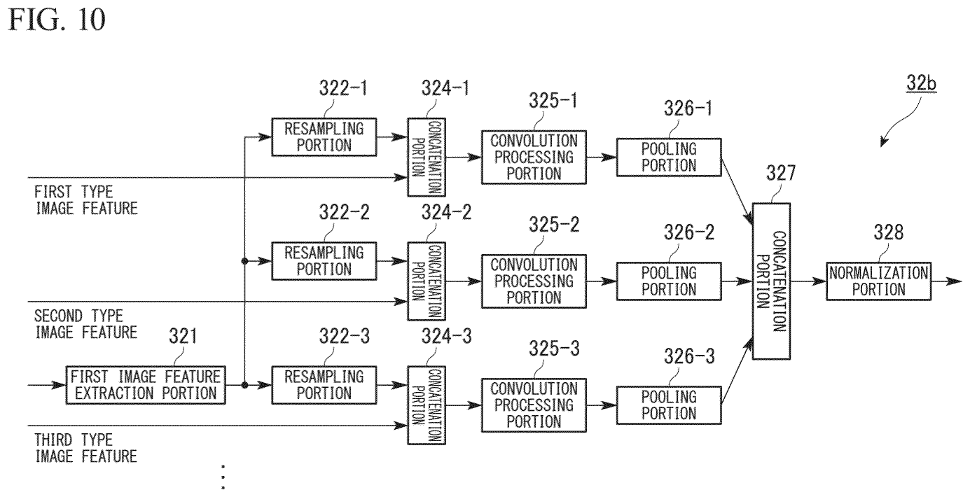

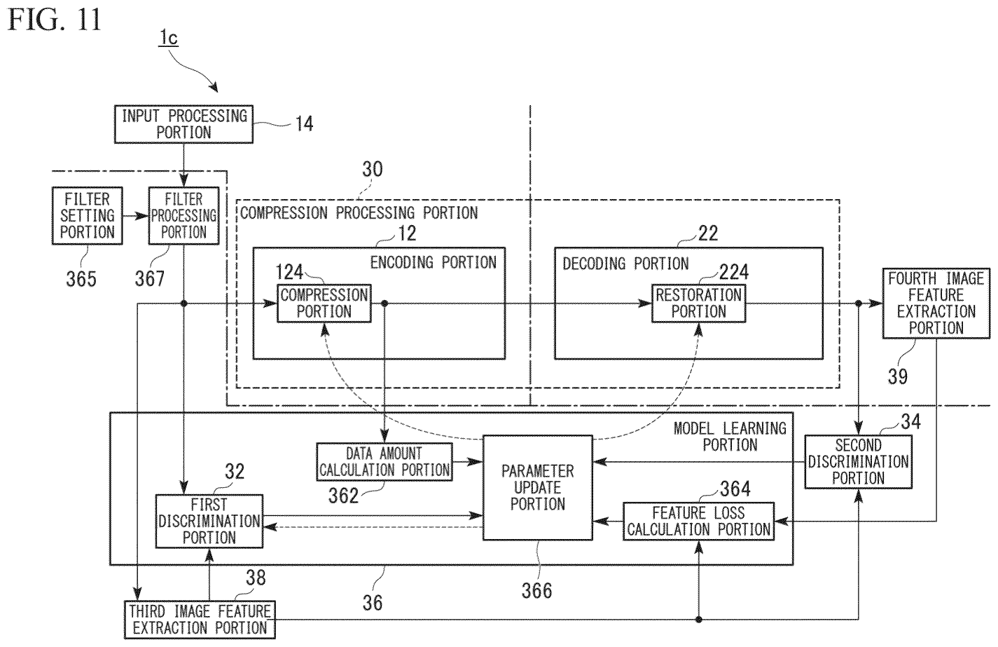

FIG. 10 is a schematic block diagram showing an example configuration of the first discrimination portion 32b. However, the first discrimination portion 32b as a whole is a CNN, and the case in which three types of image features are included as elements of the third image feature is used as an example. The first discrimination portion 32b has a first image feature extraction portion 321, resampling portions 322-1 to 322-3, concatenation portions 324-1 to 324-3, convolution processing portions 325-1 to 325-3, pooling portions 326-1 to 326-3, a concatenation portion 327, and a normalization portion 328.

The first image feature extraction portion 321 extracts first image features from the original image using a predetermined first image feature extraction model. The first image feature extraction portion 321 outputs the extracted first image feature to the resampling portion 322-1 through the resampling portion 322-3. The first image feature, and the first type image feature through third type image feature may be represented, for example, as a bitmap with a two-dimensional distribution of color signal values for each color. Color signal values across different colors are superimposed in the height direction. The bitmap has signal values for each sample point arranged at regular intervals in the horizontal and vertical directions on a two-dimensional plane, respectively. In this example, it is assumed that each sample of the first image feature and each of the first through third type image features is assumed to constitute three-dimensional data distributed in the horizontal, vertical, and height directions. The term “three-dimensional” refers to the number of dimensions in the space where samples are arranged and does not signify the number of elements constituting each image feature, i.e., the number of samples. The number of dimensions for resampling is expressed in terms of the number of samples in each of the horizontal and vertical directions.

The resampling portions 322-1 to 322-3 resample each first image feature input from the first image feature extraction portion 321 and transform it so that the number of dimensions for each color is equal to the number of dimensions of the first type image feature through the third type image feature. The resampling portions 322-1 through 322-3 output the transformed first image feature to the concatenation portions 324-1 through 324-3.

The concatenation portion 324-1 receives the transformed first image feature from the resampling portion 322-1 and the first type image feature. The concatenation portion 324-1 stacks and concatenates the transformed first image feature and first type image feature in the height direction, and outputs the resulting first type concatenated feature to the convolution processing portion 325-1.

The concatenation portion 324-2 receives the transformed first image feature from the resampling portion 322-2 and the second type image feature. The concatenation portion 324-2 stacks and concatenates the transformed first image feature and second type image feature in the height direction, and outputs the resulting second type concatenated feature to the convolution processing portion 325-2.

The concatenation portion 324-3 receives the transformed first image feature from the resampling portion 322-3 and the third type image feature. The concatenation portion 324-3 stacks and concatenates the transformed first image feature and third type image feature in the height direction, and outputs the resulting third type concatenated feature to the convolution processing portion 325-3.

The convolution processing portions 325-1 through 325-3 take as input values the color signal values that form the first through third type concatenated features, respectively, and perform convolution operations on each input value to calculate the output value. The number of samples of the calculated output values may be equal to or less than the number of samples of the input values. However, at this stage, it is assumed that each sample is distributed in three-dimensional space. The convolution processing portions 325-1 through 325-3 may each have a configuration similar to that of a CNN. The convolution processing portions 325-1 through 325-3 output a convolution output consisting of an output value for each element to the pooling portions 326-1 through 326-3, respectively.

The pooling portions 326-1 through 326-3 each average the input values of the individual sample convolution outputs from the convolution processing portions 325-1 through 325-3 in the horizontal and vertical directions in each two-dimensional plane (global pooling), and output the pooling output with the obtained average value as the output value to the concatenation portion 327. The pooling output is a one-dimensional data (vector) that contains multiple output values as elements in the height direction.

The concatenation portion 327 concatenates the pooling outputs input from the pooling portions 326-1 through 326-3, respectively, by combining them in the height direction to compose a concatenated output. The concatenation portion 327 outputs the composed concatenated output to the normalization portion 328.

The normalization portion 328 calculates the weighted sum of the input values for each sample that forms the concatenated output input from the concatenation portion 327, and normalizes the calculated weighted sum to fall between 0 and 1 as a value range. The normalization portion 328 outputs the calculated value obtained by normalization as a confidence level to the parameter update portion 366. The normalization portion 328 is, for example, a multilayer perceptron (MLP).

The second discrimination portion 34b (not shown) should have the same configuration as the first discrimination portion 32b. The functions and configuration of the second discrimination portion 34b are referenced from the description of the first discrimination portion 32b.

### Third Example Embodiment

Next, the third example embodiment shall be described. The information processing system 1 according to the third example embodiment includes a filter setting portion 365 and a filter processing portion 367.

The filter setting portion 365 sets a spatial filter with different spatial frequency features depending on the position to the filter processing portion 367.

The filter processing portion 367 performs filtering on the original image shown in the image data input from the input processing portion 14 using the spatial filter set by the filter setting portion 365. The filter processing portion 367 outputs image data indicating the processed original image (hereinafter referred to as “processed image”) to the compression portion 124, the first discrimination portion 32, and the third image feature extraction portion 38.

The above spatial filter is a low-pass filter (LPF). The spatial filter may be, for example, a Gaussian filter. A Gaussian filter is a low-pass filter whose filter coefficients are determined based on a normal distribution whose origin is the pixel to be processed. The Gaussian filter has the feature that the larger the standard deviation or variance of the normal distribution (hereinafter collectively referred to as “variance”), the more high-frequency components with high spatial frequency are blocked and low-frequency components are left. Filter processing using such spatial filters results in a processed image that is blurred more than the surrounding areas in the case where the low-pass features of some areas are high. The spatial filter may be configured as a sharpness map with spatial frequency features set for each pixel. The sharpness map can be composed with the distribution of the standard deviation of the Gaussian filter in a single frame image.

The sharpness map may be defined using a normal distribution where the distribution of sharpness is separate from the individual Gaussian filters. The distribution of sharpness, for example, the sharpness distribution center at the position with the lowest sharpness, is represented by the coordinates of the origin of the Gaussian distribution representing the sharpness distribution, and the sharpness spread, indicating the extent of sharpness, is expressed by the variance of that Gaussian distribution. Display regions with low-pass features in the spatial filter may be avoided without including the specific regions for discrimination by the first discrimination portion 32. This ensures that high-frequency components with high spatial frequency are not lost in the specific regions of the processed image.

In learning the parameter set of the machine learning model, the filter setting portion 365 may set a spatial filter with different spatial frequency features for each frame of supervised data. In training the discriminator, the parameter update portion 366 uses the first image feature discriminated from the processed image, the second image feature discriminated from the reconstructed image based on the processed image obtained from the compressed data generated from the processed image, and the third image feature extracted from the processed image to determine the parameter set of the first machine learning model. In training the generator, the parameter update portion 366 determines the respective parameter sets of the second and third machine learning models using the first image feature, the second image feature, the third image feature, and the fourth image feature discriminated from the reconstructed image based on the processed image.

When setting a spatial filter with different spatial frequency features for each frame, the filter setting portion 365 may, for example, randomly determine the sharpness distribution center and sharpness variance, which represent the distribution of sharpness, using pseudorandom numbers for each frame. This results in the synthesis of images that represent different patterns due to differences in the distribution of sharpness, and the synthesized images are used as supervised data. Even when the amount of supervised data is limited, the machine learning model can be trained to obtain reconstructed images that can achieve high-quality and highly accurate image recognition.

### Fourth Example Embodiment

Next, the fourth example embodiment shall be described. In training the generator, the parameter update portion 366 of the present example embodiment uses the larger value (maximum value) of the information amount of the compressed data −log(Q(z)) and the target value B of that information amount as the bit rate loss. As shown in Equation (3), the bit-rate loss max (−log(Q(z)), B) is included as a component of the second loss function L_{E,G,Q}. In training the generator, the second loss function L_{E,G,Q} is minimized, so the parameter sets of the second machine learning model for the compression portion 124 and the third machine learning model for the restoration portion 224 are determined so that the information amount of the compressed data −log(Q(z)) does not exceed the target value B.

$$Equation 3 ]$$

$${L}_{F , G , Q} = {E}_{x ∼ p ( x )} [ - α log D ( {x}^{′} \vert f ) + β {‖ F ( {x}^{′} - f ‖}_{1} + max ( - log Q ( z ) , B ) ] \qquad ( 3 )$$

### (Minimum Configuration)

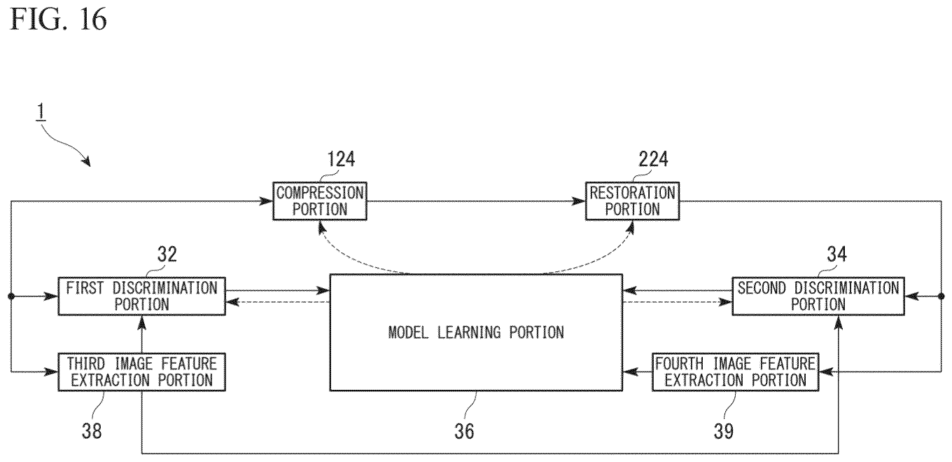

Next, the minimum configuration of the abovementioned example embodiments will be described. FIG. 16 is a schematic block diagram showing a minimum configuration example of the information processing system 1 of the present application. The information processing system 1 includes: a first discrimination portion 32 that, using a first machine learning model on an original image, discriminates a first image feature in a specific region of the original image; a compression portion 124 that, using a second machine learning model on the original image, generates compressed data with a reduced data amount; a restoration portion 224 that, using a third machine learning model, generates a reconstructed image of the original image from the compressed data; a second discrimination portion 34 that, using a fourth machine learning model on the reconstructed image, discriminates a second image feature in a specific region of the reconstructed image; a third image feature extraction portion 38 that extracts a third image feature for recognition of a subject from the original image; a fourth image feature extraction portion 39 that extracts a fourth image feature for recognition of the subject from the reconstructed image; and a model learning portion 36. The model learning portion 36 makes a parameter set of the fourth machine learning model common to the parameter set of the first machine learning model, determines a parameter set of the first machine learning model such that a first loss function, which indicates the degree of variation from a conditional confidence of the first image feature conditional on the third image feature to a conditional confidence of the second image feature conditional on the third image feature, becomes larger, and determines a parameter set for each of the second and third machine learning models such that the second loss function, obtained by synthesizing the conditional confidence of the second image feature conditional on the third image feature and a feature loss function indicating the degree of variation from the third image feature to the fourth image feature, becomes smaller.

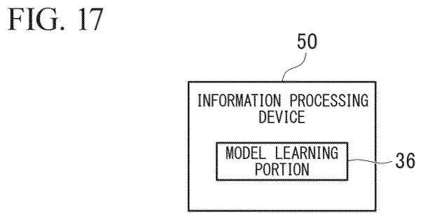

FIG. 17 is a schematic block diagram showing a minimum configuration example of the information processing device 50. The information processing device 50 includes the model learning portion 36 that sets, as a condition, a third image feature for recognition of a subject extracted from an original image, determines a parameter set of the first machine learning model such that a first loss function indicating the degree of change from a conditional confidence of a first image feature discriminated in a specific region of the original image by using a first machine learning model on the original image to a conditional confidence conditional on the third image feature, which is a conditional confidence of a second image feature discriminated in a specific region of a reconstructed image using a fourth machine learning model that shares the same parameter set as the first machine learning model for the reconstructed image of the original image generated using a third machine learning model from the compressed data with a reduced data amount generated using a second machine learning model for the original image, becomes larger; and determines a parameter set for each of a second machine learning model and a third machine learning model such that a second loss function, obtained by synthesizing the conditional confidence of the second image feature conditional on the third image feature and a feature loss function indicating the degree of variation from the third image feature to a fourth image feature for recognition of the subject extracted from the reconstructed image, becomes smaller.

Each of the above devices, e.g., edge device, server device, information processing device, monitoring support device, etc., may include a computer system. The computer system includes one or more processors, such as a central processing unit (CPU). Each of the above-mentioned processes is stored in a computer-readable storage medium in the form of a program for each device, and the computer reads and executes this program to perform these processes. Computer systems shall include software such as operating systems (OS), device drivers, and utility programs, as well as hardware such as peripheral devices. “Computer-readable recording media” refers to portable media such as magnetic disks, optical disks, ROM (Read Only Memory), semiconductor memory, and other storage devices such as hard disks built into computer systems. Furthermore, “computer-readable recording media” may also include one that holds the program dynamically for a short time, such as a communication lines in the case of transmitting the program using a network such as the Internet or communication lines such as telephone lines, and one that holds the program for a fixed period of time, such as volatile memory inside a computer system that serves as the server or client in such cases. The above program may be used to realize some of the aforementioned functions, and may also be a so-called differential file (differential program), which can furthermore realize the aforementioned functions in combination with a program already recorded in the computer system.

In addition, some or all of the devices or equipment in the example embodiments described above may be realized as integrated circuits such as LSI (Large Scale Integration). Each functional block of an individual device or equipment may be processorized individually, or it may be partially or fully integrated into a processor. The method of circuit integration is not limited to LSI, but may be realized with dedicated circuits or general-purpose processors. If an integrated circuit technology has emerged as an alternative to LSI due to advances in semiconductor technology, an integrated circuit based on such technology may be used.

The aforementioned example embodiments may be realized as follows.

(Supplementary Note 1) An information processing system comprising: a first discrimination means that, by using a first machine learning model on an original image, discriminates a first image feature in a specific region of the original image; a compression means that, by using a second machine learning model on the original image, generates compressed data having a reduced data amount; a restoration means that, by using a third machine learning model, generates a reconstructed image of the original image from the compressed data; a second discrimination means that, by using a fourth machine learning model on the reconstructed image, discriminates a second image feature in a specific region of the reconstructed image; a third image feature extraction means that extracts a third image feature for recognition of a subject from the original image; a fourth image feature extraction means that extracts a fourth image feature for recognition of the subject from the reconstructed image; and a model learning means that makes a parameter set of the fourth machine learning model common to a parameter set of the first machine learning model, determines the parameter set of the first machine learning model such that a first loss function becomes larger, the first loss function indicating a degree of variation from a conditional confidence of the first image feature conditional on the third image feature to a conditional confidence of the second image feature conditional on the third image feature, and determines a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to the fourth image feature.

(Supplementary Note 2) The information processing system according to supplementary note 1, wherein the second loss function is further synchronized with an information loss function based on the information amount of the compressed data.

(Supplementary Note 3) The information processing system according to supplementary note 2, wherein the information loss function is a maximum value between an information amount of the compressed data and a target value of the information amount.

(Supplementary Note 4) The information processing system according to any one of supplementary notes 1 to 3, wherein the third image feature and the fourth image feature each include an image feature for recognizing multiple types of subjects.

(Supplementary Note 5) The information processing system according to any one of supplementary notes 1 to 4, comprising: a filter processing means, wherein the filter processing means generates a processed image by filtering the original image with a different spatial frequency feature for each frame; and the model learning means determines the parameter set of the first machine learning model using the first image feature discriminated from the processed image, the second image feature discriminated from the reconstructed image based on the processed image obtained from compressed data generated from the processed image, and the third image feature extracted from the processed image, and determines the parameter set of each of the second machine learning model and third machine learning model using the first image feature, the second image feature, the third image feature, and the fourth image feature discriminated from the reconstructed image based on the processed image.

(Supplementary Note 6) The information processing system according to any one of supplementary notes 1 to 5, comprising: a transmitter comprising the first discrimination means and the compression means; a receiver comprising the restoration means and the second discrimination means; and a parameter notification means, wherein the model learning means comprises: a first discrimination means for learning that discriminates the first image feature for the original image; a compression means for learning that generates the compressed data for the original image; a restoration means for learning that generates a reconstructed image of the original image from the compressed data; a second discrimination means for learning that discriminates a second image feature in a specific region of the reconstructed image by using a fourth machine learning model on the reconstructed image; a third image feature extraction means that extracts a third image feature for recognition of a subject from the original image; and a fourth image feature extraction means that extracts a fourth image feature for recognition of the subject from the reconstructed image, and the parameter notification means notifies the first discrimination means, the compression means, the restoration means, and the second discrimination means of the first machine learning model parameter set, second machine learning model parameter set, third machine learning model parameter set, and fourth machine learning model parameter set determined by the model learning means.

(Supplementary Note 7) The information processing system according to any one of supplementary notes 1 to 6, wherein the first image feature, the second image feature, the third image feature, and the fourth image feature each have a plurality of element values, the first discrimination means comprises: a first image feature extraction means that extracts the first image feature from the original image; a first resampling means that resamples the first image feature so that number of elements of the first image feature equals number of elements of the third image feature; and a first confidence calculation means that calculates a conditional confidence of the first image feature from a first combined image feature obtained by combining the resampled first image feature and the third image feature, and the second discrimination means comprises: a second image feature extraction means that extracts the second image feature from the reconstructed image; a second resampling means that resamples the second image feature so that number of elements of the second image feature equals number of elements of the fourth image feature; and a second confidence calculation means that calculates a conditional confidence of the second image feature from a second combined image feature obtained by combining the resampled second image feature and the fourth image feature.

(Supplementary Note 8) The information processing system according to any one of supplementary notes 1 to 7, wherein the first loss function is a sum of a logarithmic value of the conditional confidence of the first image feature conditional on the third image feature and a logarithmic value of a conditional inverse confidence of the second image feature conditional on the third image feature, and the second loss function includes a component that takes a logarithmic value of the conditional confidence of the second image feature conditional on the third image feature as a generator loss and a component that takes a first order norm of a difference of the fourth image feature from the third image feature as the feature loss function.

(Supplementary Note 9) An information processing method in an information processing system comprising: a first discrimination step of, by using a first machine learning model on an original image, discriminating a first image feature in a specific region of the original image; a compression step of, by using a second machine learning model on the original image, generating compressed data having a reduced data amount; a restoration step of, by using a third machine learning model, generating a reconstructed image of the original image from the compressed data; a second discrimination step of, by using a fourth machine learning model on the reconstructed image, discriminating a second image feature in a specific region of the reconstructed image; a third image feature extraction step of extracting a third image feature for recognition of a subject from the original image; a fourth image feature extraction step of extracting a fourth image feature for recognition of the subject from the reconstructed image; and a model learning step of making a parameter set of the fourth machine learning model common to a parameter set of the first machine learning model, determining the parameter set of the first machine learning model such that a first loss function becomes larger, the first loss function indicating a degree of variation from a conditional confidence of the first image feature conditional on the third image feature to a conditional confidence of the second image feature conditional on the third image feature, and determining a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to the fourth image feature.

(Supplementary Note 10) An information processing device comprising: a model learning means determines a parameter set of a first machine learning model such that a first loss function becomes larger, the first loss function indicating a degree of variation from a conditional confidence of a first image feature conditional on a third image feature to a conditional confidence of a second image feature conditional on the third image feature, the third image feature being an image feature for recognition of a subject extracted from an original image, the first image feature being discriminated in a specific region of the original image by using a first machine learning model on the original image, the second image feature being discriminated by using a fourth machine learning model on a reconstructed image of the original image, the reconstructed image being generated from compressed data by using a third machine learning model, the compressed data having a reduced data amount and being generated by using a second machine learning model on the original image, a parameter set of the fourth machine learning model being common to a parameter set of the first machine learning model, and determines a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to a fourth image feature for recognition of the subject from the reconstructed image.

(Supplementary Note 11) A storage medium that stores a program for causing a computer to function as an information processing device according to supplementary note 10.

Although the preferred example embodiments of the invention have been described above, the invention is not limited to these example embodiments and variations thereof. Additions, omissions, substitutions, and other changes in configuration are possible without departing from the main idea of the invention.

The direction of the arrows in the block diagrams and other drawings is for convenience of explanation, and the disclosure in the present application does not limit the direction of flow of information, data, signals, etc. in implementation.

The invention is not limited by the foregoing description, but only by the appended claims.

### INDUSTRIAL APPLICABILITY

According to each of the above information processing system, information processing device, information processing method, and storage medium, the reconstructed image obtained using the second machine learning model and third machine learning is conditioned on the third image feature, and the visual quality is improved by having the second image feature that has significant variation from the first image feature. The same method used to extract the third image feature from the original image can be used to extract the fourth image feature from the reconstructed image so that the variation from the third image feature is reduced. Therefore, the subjective quality of the reconstructed image and the recognition rate of image recognition using the fourth image feature extracted from the reconstructed image can be improved.

### DESCRIPTION OF REFERENCE SYMBOLS

1, 1a . . . 1c Information processing system, 12 . . . Encoding portion, 14 . . . Input processing portion, 16 . . . Imaging portion, 22 . . . Decoding portion, 30 . . . Compression processing portion, 32, 32b . . . First discrimination portion (first discrimination means), 34 . . . Second discrimination portion (second discrimination means), 36 . . . Model learning portion (model learning means), 38, 38b . . . Third image feature extraction portion (third image feature extraction means), 39 . . . Fourth image feature extraction portion (fourth image feature extraction means), 42 . . . Image recognition portion, 44 . . . Detection portion, 46 . . . Display processing portion, 47 . . . Display portion, 48 . . . Operation input portion, 124 . . . Compression portion (compression means), 224 . . . Restoration portion (restoration means), 321 . . . First image feature extraction portion, 322 (322-1 to 322-3) . . . Resampling portion, 324 (324-1 to 324-3) . . . Concatenation portion, 325 (325-1 to 325-3) . . . Convolution processing portion, 326 (326-1 to 326-3) . . . Pooling portion, 327 . . . Concatenation portion, 328 . . . Normalization portion, 362 . . . Data amount calculation portion, 364 . . . Feature loss calculation portion, 365 . . . Filter setting portion, 366 . . . Parameter update portion, 367 . . . Filter processing portion, 382, 382-1 . . . First type image feature extraction portion, 382-2 . . . Second type image feature extraction portion, 382-3 . . . Third type image feature extraction portion, 1242 . . . Feature analysis portion, 1244 . . . First distribution estimation portion, 1246 . . . First sampling portion, 2242 . . . Second distribution estimation portion, 2244 . . . Second sampling portion, 2246 . . . Data generation portion

What is claimed is:

1. An information processing system comprising:
a memory configured store instructions; and
a processor configured to execute the instructions to:
by using a first machine learning model on an original image, discriminate a first image feature in a specific region of the original image;
by using a second machine learning model on the original image, generate compressed data having a reduced data amount;
by using a third machine learning model, generate a reconstructed image of the original image from the compressed data;
by using a fourth machine learning model on the reconstructed image, discriminate a second image feature in a specific region of the reconstructed image;
extract a third image feature for recognition of a subject from the original image;
extract a fourth image feature for recognition of the subject from the reconstructed image; and
make a parameter set of the fourth machine learning model common to a parameter set of the first machine learning model;
determine the parameter set of the first machine learning model such that a first loss function becomes larger, the first loss function indicating a degree of variation from a conditional confidence of the first image feature conditional on the third image feature to a conditional confidence of the second image feature conditional on the third image feature; and
determine a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to the fourth image feature.

2. The information processing system according to claim 1, wherein the second loss function is further synchronized with an information loss function based on the information amount of the compressed data.

3. The information processing system according to claim 2, wherein the information loss function is a maximum value between an information amount of the compressed data and a target value of the information amount.

4. The information processing system according to claim 1, wherein the third image feature and the fourth image feature each include an image feature for recognizing multiple types of subjects.

5. The information processing system according to claim 1, wherein
the processor is configured to execute the instructions to
generate a processed image by filtering the original image with a different spatial frequency feature for each frame, and
the processor is configured to execute the instructions to
determine the parameter set of the first machine learning model using the first image feature discriminated from the processed image, the second image feature discriminated from the reconstructed image based on the processed image obtained from compressed data generated from the processed image, and the third image feature extracted from the processed image, and
determine the parameter set of each of the second machine learning model and third machine learning model using the first image feature, the second image feature, the third image feature, and the fourth image feature discriminated from the reconstructed image based on the processed image.

6. The information processing system according to claim 1, comprising:
a transmitter;
a receiver; and
wherein the processor is configured to execute the instructions to
discriminate the first image feature for the original image;
generate the compressed data for the original image;
generate a reconstructed image of the original image from the compressed data;
discriminate a second image feature in a specific region of the reconstructed image by using a fourth machine learning model on the reconstructed image;
extract a third image feature for recognition of a subject from the original image; and
extract a fourth image feature for recognition of the subject from the reconstructed image.

7. The information processing system according to claim 1, wherein
the first image feature, the second image feature, the third image feature, and the fourth image feature each have a plurality of element values,
the processor is configured to execute the instructions to:
extract the first image feature from the original image;
resample the first image feature so that number of elements of the first image feature equals number of elements of the third image feature; and
calculate a conditional confidence of the first image feature from a first combined image feature obtained by combining the resampled first image feature and the third image feature, and
the processor is configured to execute the instructions to
extract the second image feature from the reconstructed image;
resample the second image feature so that number of elements of the second image feature equals number of elements of the fourth image feature; and
calculate a conditional confidence of the second image feature from a second combined image feature obtained by combining the resampled second image feature and the fourth image feature.

8. The information processing system according to claim 1, wherein
the first loss function is a sum of a logarithmic value of the conditional confidence of the first image feature conditional on the third image feature and a logarithmic value of a conditional inverse confidence of the second image feature conditional on the third image feature, and
the second loss function includes a component that takes a logarithmic value of the conditional confidence of the second image feature conditional on the third image feature as a generator loss and a component that takes a first order norm of a difference of the fourth image feature from the third image feature as the feature loss function.

9. An information processing method for an information processing system comprising:
by using a first machine learning model on an original image, discriminating a first image feature in a specific region of the original image;
by using a second machine learning model on the original image, generating compressed data having a reduced data amount;
by using a third machine learning model, generating a reconstructed image of the original image from the compressed data;
by using a fourth machine learning model on the reconstructed image, discriminating a second image feature in a specific region of the reconstructed image;
extracting a third image feature for recognition of a subject from the original image;
extracting a fourth image feature for recognition of the subject from the reconstructed image;
making a parameter set of the fourth machine learning model common to a parameter set of the first machine learning model;
determining the parameter set of the first machine learning model such that a first loss function becomes larger, the first loss function indicating a degree of variation from a conditional confidence of the first image feature conditional on the third image feature to a conditional confidence of the second image feature conditional on the third image feature; and
determining a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to the fourth image feature.

10. An information processing device comprising:
a memory configured store instructions; and
a processor configured to execute the instructions to:
determine a parameter set of a first machine learning model such that a first loss function becomes larger, the first loss function indicating a degree of variation from a conditional confidence of a first image feature conditional on a third image feature to a conditional confidence of a second image feature conditional on the third image feature, the third image feature being an image feature for recognition of a subject extracted from an original image, the first image feature being discriminated in a specific region of the original image by using a first machine learning model on the original image, the second image feature being discriminated by using a fourth machine learning model on a reconstructed image of the original image, the reconstructed image being generated from compressed data by using a third machine learning model, the compressed data having a reduced data amount and being generated by using a second machine learning model on the original image, a parameter set of the fourth machine learning model being common to a parameter set of the first machine learning model; and
determine a parameter set of each of the second machine learning model and the third machine learning model such that a second loss function becomes smaller, the second loss function being a function obtained by synthesizing a conditional confidence of the second image feature conditional on the third image feature and a feature loss function indicating a degree of variation from the third image feature to a fourth image feature for recognition of the subject from the reconstructed image.

11. (canceled)

12. The information processing method according to claim 9, wherein the second loss function is further synchronized with an information loss function based on the information amount of the compressed data.

13. The information processing method according to claim 12, wherein the information loss function is a maximum value between an information amount of the compressed data and a target value of the information amount.

14. The information processing method according to claim 9, wherein the third image feature and the fourth image feature each include an image feature for recognizing multiple types of subjects.

15. The information processing method according to claim 9, further comprising:
generating a processed image by filtering the original image with a different spatial frequency feature for each frame, and
wherein determining the parameter set of the first machine learning model comprises determining the parameter set of the first machine learning model using the first image feature discriminated from the processed image, the second image feature discriminated from the reconstructed image based on the processed image obtained from compressed data generated from the processed image, and the third image feature extracted from the processed image, and
determining the parameter set of each of the second machine learning model and the third machine learning model comprises determining the parameter set of each of the second machine learning model and third machine learning model using the first image feature, the second image feature, the third image feature, and the fourth image feature discriminated from the reconstructed image based on the processed image.

16. The information processing method according to claim 9, wherein
the first image feature, the second image feature, the third image feature, and the fourth image feature each have a plurality of element values,
discriminating the first image feature comprises:
extracting the first image feature from the original image;
resampling the first image feature so that number of elements of the first image feature equals number of elements of the third image feature; and
calculating a conditional confidence of the first image feature from a first combined image feature obtained by combining the resampled first image feature and the third image feature, and
discriminating the second image feature comprises:
extracting the second image feature from the reconstructed image;
resampling the second image feature so that number of elements of the second image feature equals number of elements of the fourth image feature; and
calculating a conditional confidence of the second image feature from a second combined image feature obtained by combining the resampled second image feature and the fourth image feature.

17. The information processing method according to claim 9, wherein
the first loss function is a sum of a logarithmic value of the conditional confidence of the first image feature conditional on the third image feature and a logarithmic value of a conditional inverse confidence of the second image feature conditional on the third image feature, and
the second loss function includes a component that takes a logarithmic value of the conditional confidence of the second image feature conditional on the third image feature as a generator loss and a component that takes a first order norm of a difference of the fourth image feature from the third image feature as the feature loss function.
